(19) United States
(12) Patent Application Publication
(10) Pub. No.: US 2026/0228217 A1
(43) Pub. Date: Aug. 6, 2026

(54) NETWORK RESOURCE DEPLOYMENT USING AUTOMATED SYNTHETIC TIME SERIES DATA GENERATION METHOD AND APPARATUS

(71) Applicant: VERIZON PATENT AND LICENSING INC., Basking Ridge, NJ (US)

(72) Inventors: Aravind SARAVANAN, Chennai (IN); Kalyani DACHA, Telangana (IN); Ravi HS, Bangalore (IN)

(73) Assignee: VERIZON PATENT AND LICENSING INC., Basking Ridge, NJ (US)

(21) Appl. No.: 19/043,880

(22) Filed: Feb. 3, 2025

(51) Int. Cl. G06F 16/2453; G06F 16/2458; G06N 3/094

(52) U.S. Cl. CPC G06F 16/2453; G06F 16/2477; G06N 3/094

(57) ABSTRACT

Techniques for automatically validating and optimizing structured query generation in connection with a natural language (NL) prompt are disclosed. In one embodiment, a computerized method performed by a computing device is disclosed comprising obtaining actual time series data values, analyzing the actual data values and identifying, based on the analysis, at least a residual component corresponding to each data value of the actual time series, determining a modified time series using the actual time series, the generating comprising generating modified data values by removing the residual component from each actual data value of the actual time series, training a generative adversarial network (GAN) comprising a generator neural network and a discriminator neural network using the modified time series as training data for the generator, determining a synthetic time series comprising synthetic data values using the trained GAN, and performing time series analysis using the synthetic time series.

### BACKGROUND INFORMATION

A time series generally refers to a set of observations that are made at successive equally-spaced points in time. Each observation can be represented as a data value and the set of temporally-organized data values can be referred to as time series data. A set of observations can be made in connection with a specific subject, entity, etc. The annual population of a city over a ten-year span, the daily closing price of a stock over the span of a year, the daily call volume experienced by a call center over the span of a month, network bandwidth measured for a communications network connection over a day, month, etc. are just a few examples of time series data. In each of these examples, actual, or real, data values are readily available. This is not always the case, however. In some cases, there may be an insufficient amount of real data. In certain domains, real time series data can contain sensitive or personally identifiable information and use of such data can raise privacy and data protection concerns. For a myriad of reasons, actual time series data may be sparse or altogether unavailable.

### BRIEF DESCRIPTION OF THE DRAWINGS

FIG. 1 provides an example illustrating components of a synthetic time series engine used in accordance with embodiments of the present disclosure;

FIG. 2 provides an example illustrating actual time series data and component parts thereof in accordance with one or more embodiments of the present disclosure;

FIG. 3 provides an example illustrating components of actual and modified data values in accordance with one or more embodiments of the present disclosure;

FIG. 4 provides a examples of conditional features in connection with a physical receive buffer unit (PRBU) buffer status example in accordance with one or more embodiments of the present disclosure;

FIG. 5 provides an exemplary example illustrating time series data decomposition involving actual time series data values in accordance with one or more embodiments;

FIG. 6 provides a synthetic time series generation process flow in accordance with one or more embodiments of the present disclosure;

FIG. 7 provides an exemplary example graphically illustrating actual PRBU time series data, and synthetic PRBU synthetic time series data generated in accordance with one or more embodiments of the present disclosure;

FIG. 8 provides an example illustrating the accuracy of synthetic time series data generated in connection with a number of use cases in accordance with one or more embodiments of the present disclosure;

FIG. 9, which includes FIGS. 9A, 9B and 9C, provides an exemplary example graphically illustrating actual call center volume time series data, and synthetic call center volume time series data generated in accordance with one or more embodiments of the present disclosure;

FIG. 10 provides an exemplary example graphically illustrating actual channel quality (CQI) time series data and synthetic CQI synthetic time series data generated in accordance with one or more embodiments of the present disclosure; and

FIG. 11 provides a block diagram illustrating a computing device showing an example of client or server device used in accordance with one or more embodiments of the present disclosure.

### DETAILED DESCRIPTION OF EXAMPLE EMBODIMENTS

Allocating network or other resources in complex systems presents challenges when real time, or near real time, or actual data is unavailable. For this reason, often synthetic data is generated in order to train models or the like, but this synthetic data is non-time series data that lacks a time factor. That is, synthetic data that is generated is not temporally organized and is a poor approximation of real time series data that is temporally-organized. Improved techniques for automatically generating synthetic data values with associated temporal information, or synthetic time series data, are disclosed. Disclosed systems and methods can use a generative adversarial network (GAN) to generate synthetic data values of a synthetic time series data for use in network resource allocation, or allocation of resources in other systems, such as call centers, by way of non-limiting examples. Unlike a conventional GAN trained to generate discrete data such as a synthesized image, embodiments of the present disclosure train a GAN to generate synthesized time series data comprising a set of synthesized data values organized in time-a temporally-organized set of synthesized data values.

Embodiments of the present disclosure are described herein in connection with an exemplary application involving a physical receive buffer unit (PRBU) of a base station of a telecommunications network (e.g., a 5G communications network). A PRBU can be configured to temporarily store data packets received by a base station from user equipment (UE) until they can be processed by the telecommunications network. The PRBU can maintain buffer status information. The PRBU can provide buffer status information to a management function of the network, which can use the buffer status information, along with buffer status information from other PRBUs associated with a number of other base stations, to identify and accommodate data packet reception fluctuations and provide acceptable data flow conditions during periods of high network traffic by, for example, allocating or reallocating computing resources to the base station(s) experiencing the high volume, redistributing UEs to other base stations, etc.

In a case that a PRBU fails to provide actual buffer status information, a GAN trained using historical, actual, PRBU buffer status information in accordance with embodiments of the present disclosure can be used to generate synthetic buffer status information, which can be provided to the network management function and used in place of actual buffer status information to manage data packets reception fluctuations, etc. It should be apparent that PRBU buffer status information is one example of synthetic time series data. The disclosed GAN can be used in connection with other applications and other types of synthetic time series data, such as and without limitation call volume, network bandwidth, etc. synthetic time series data.

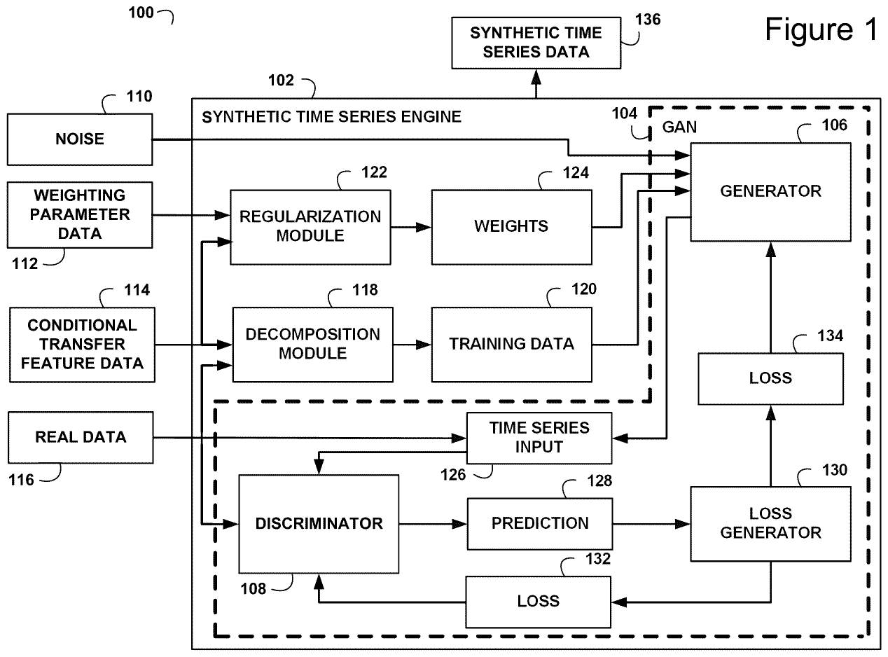

In accordance with one or more embodiments of the present disclosure, the GAN used to generate synthetic time series data can comprise two neural networks-a generator neural network, or generator, and a discriminator neural network, or discriminator. The GAN can be a component of a synthetic time series engine. FIG. 1 provides an example illustrating components of a synthetic time series engine used in accordance with embodiments of the present disclosure.

In example 100, synthetic time series engine 102 comprises GAN 104. In accordance with one or more embodiments, during a training phase, GAN 104 can learn a distribution of real time series data, such as that included in real data 116. During a deployment phase, the trained GAN 104 can generate synthetic time series data conforming to the learned distribution. In accordance with disclosed embodiments, real data 116 comprises time series data comprising a number of actual data values, where each data value corresponds to a time interval in a set of time intervals—e.g., equally spaced time intervals.

In example 100, GAN 104 comprises generator 106, discriminator 108 and loss generator 130. Time series input 126 can be an actual time series from real data 116 or a synthetic time series generated by generator 106. Discriminator 108 can receive time series input 126 and generate a prediction indicating whether the input is an actual time series from real data 116 or a synthetic time series generated by generator 106. Loss generator can provide feedback to generator 106 and discriminator 108. During a training phase, generator 106 and discriminator 108 can be trained using an iterative process. In example 100, loss generator 130 provides loss 134 to generator 106 so that generator 106 can update its weights and provides loss 132 to discriminator 108 so that discriminator 108 can update its weights. Generator 106 can use loss 134 to learn to generate synthetic time series data that the discriminator 108 is unable to differentiate from actual time series data. Discriminator 108 can use loss 132 to maximize the probability of making a correct prediction 128. The training phase can be repeated until generator 106 learns to generate a synthetic time series that is labeled as real by discriminator 108.

In accordance with one or more embodiments, generator 106 can be trained using training data 120 and weights 124 learned during the training phase, so that the trained generator 106 learns, during the training phase, to generate synthetic time series data 136 using noise 110, which can be randomly generated data. In accordance with one or more embodiments, training data 120 can comprise modified time series data. In accordance with one or more embodiments, modified time series data can be actual time series data values modified to remove a residual component from each data value in the actual time series. In accordance with one or more embodiments, trend and seasonal components from the actual time series data values can be retained in the modified time series data values. In accordance with one or more embodiments, training data can include one or more conditional features, as is discussed in more detail below.

In accordance with one or more embodiments, actual time series data from real data 116 can comprise data values, where each data value includes a trend component, a seasonal component and a residual component. Decomposition module 118 can analyze the actual time series and identify, based on the analysis, trend, seasonal and residual components of each data value of the actual time series. The trend component can represent movement in the data over a short, intermediate, long, etc. time. The seasonality component can represent fluctuations that can repeat and be short-term, and that can be caused by factors such as seasons or cycles. The residual component can represent random variability that remains after removing trend and seasonality.

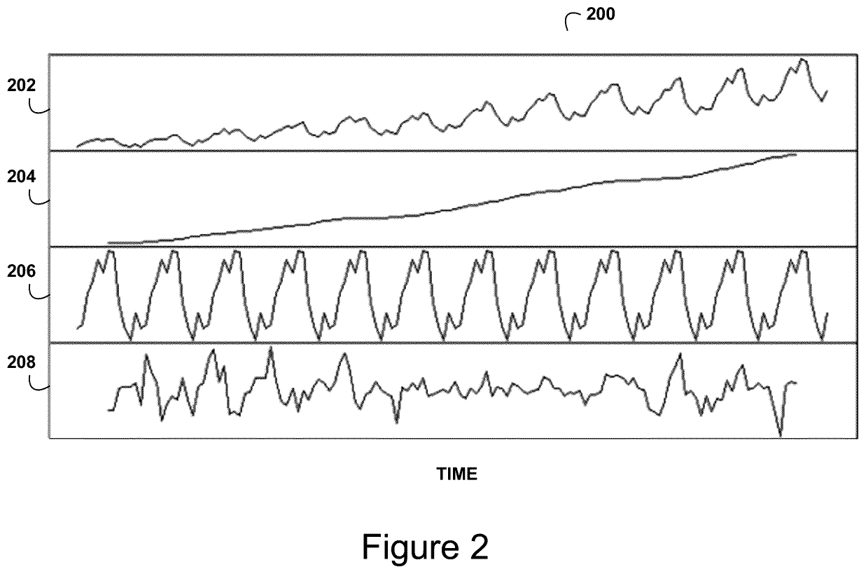

FIG. 2 provides an example illustrating actual time series data and component parts thereof in accordance with one or more embodiments of the present disclosure. In example 200, the x-axis represents time. By way of a non-limiting example, time can be representing as a set of equally-spaced intervals of time. Some non-limiting examples of equally-spaced intervals of time include seconds, minutes, hours, days, months, years, etc.

In example 200, section 202 corresponds to actual time series data values. By way of a non-limiting example, the actual time series data can be PRBU buffer status information and section 202 shows daily actual PRBU buffer status data values in an actual PRBU time series. Section 204 represents the trend component corresponding to the actual time series data, section 206 represents the seasonal component and section 208 represents the residual component. In accordance with embodiments of the present disclosure, decomposition module 118 can remove the residual component from each data value in the actual time series shown in section 202 to generate modified time series data. In accordance with one or more embodiments, trend and seasonal components from the actual time series data values can be retained in the modified time series data values. As discussed herein, the modified time series data can be included in training data 120 to train generator 106.

Referring again to FIG. 1, decomposition module 118 can generate training data 120 including modified time series data corresponding to actual time series data from real data 116. As discussed, decomposition module 118 can generate a modified time series comprising modified data values generated by removing the residual component from each actual data value of an actual time series. In accordance with one or more embodiments, trend and seasonal components from the actual time series data values can be retained in the modified time series data values.

Trend, seasonal and residual components of an actual data value, such as a PRBU buffer status data value can be expressed using the following expressions:

$${X}_{t} = {T}_{t} + {S}_{t} + {R}_{t} \qquad Expr . ( 1 )$$

$${X}_{t} = {T}_{t} * {S}_{t} * {R}_{t} \qquad Expr . ( 2 )$$

In the above expressions, Xₜ represents an actual data value, such as actual PRBU buffer status data value, at time t, Tt represents the trend component, at time t, of the actual data value, Xₜ, Sₜ represents the seasonal component, at time t, of the actual data value, Xₜ, and Rₜ represents the residual component, at time t, of the actual data value, Xₜ. Using the additive approach of Expr. (1), Xₜ can be modified to determine a modified data value, Mt, that includes the trend and seasonal components and excludes the residual component, by “subtracting” Rₜ from both sides of the expression. Using the multiplicative approach of Expr. (2), Xₜ can be modified to determine Mt by “dividing” both sides of the expression by Rₜ.

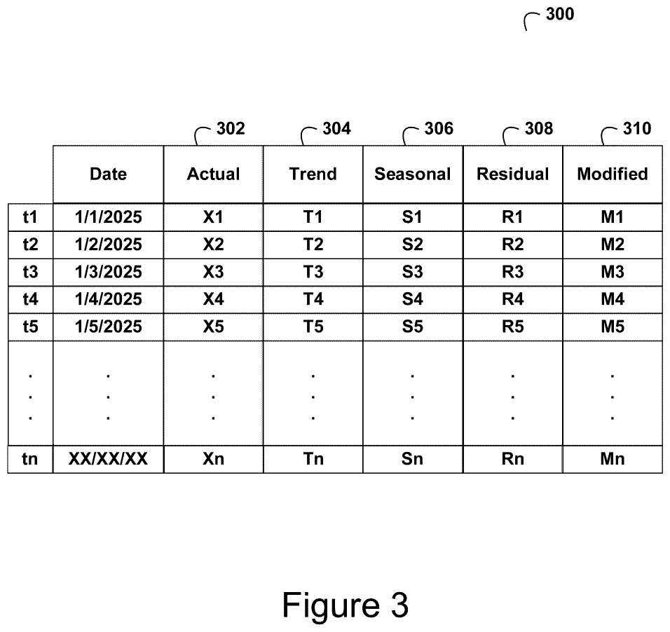

FIG. 3 provides an example illustrating components of actual and modified data values in accordance with one or more embodiments of the present disclosure. In example 300, column 302 has actual data values representing an actual time series, where each of the actual data values correspond to a time interval in a set of equally-spaced time intervals. In example 300, the time interval is a daily time interval. It should be apparent that any time interval can be used with disclosed embodiments. As shown in column 304, 306 and 308, each of the actual data values in column 302 can comprise trend, seasonal and residual components. In accordance with one or more embodiments, a modified time series comprising modified data values, shown in column 310, can be determined by removing the residual component, shown in column 308, from each of the actual data values of column 302.

Referring again to FIG. 1, in accordance with one or more disclosed embodiments, decomposition module 118 can use conditional transfer feature data 114 with actual time series data from real data 116 to generate modified time series data. Conditional transfer feature data 114 can comprise a number of conditional features, or variables, that decomposition module 118 can take into account in determining the trend, seasonal and residual components of an actual data value in an actual time series.

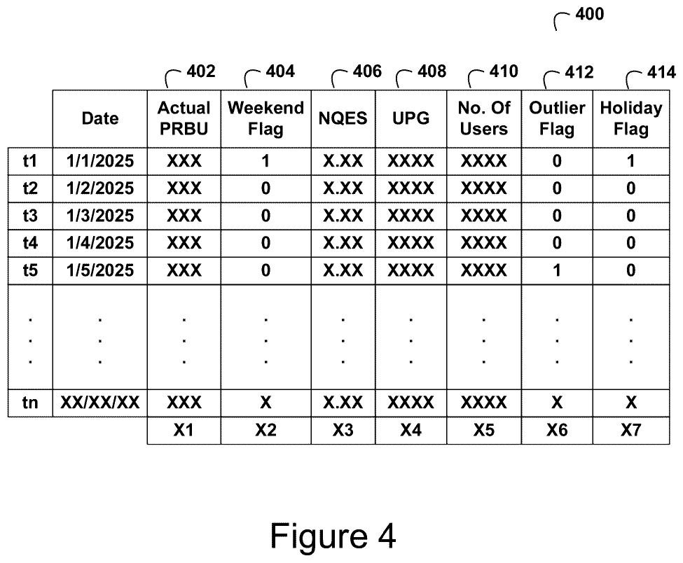

FIG. 4 provides an examples of conditional features in connection with a PRBU buffer status example in accordance with one or more embodiments of the present disclosure. In example 400, column 402 corresponds to daily actual PRBU buffer status data, which can vary from one day to the next. Columns 404-414 provide some non-limiting examples of other variables, or conditional features, that can impact, or influence, actual buffer status data. Column 404 corresponds to conditional feature data indicating whether or not the day the actual PRBU buffer status data is captured is a weekday or a weekend day. Another example of a conditional feature is network quality of experience score, or NQES, shown in column 306. Some non-limiting examples of NQES include Quality of Experience (QoE), Quality of Service (QoS), etc. Columns 408 and 410 are examples of conditional features indicating, respectively, a number of upgrade customers and number of overall users. Columns 412 and 414 can be used to indicate whether or not the corresponding actual PRBU buffer status data value is an outlier relative to other PRBU buffer status data values and whether the corresponding day corresponds to a holiday or event.

In accordance with one or more embodiments, decomposition module 118 can use the conditional features to determine the trend, seasonal and residual components of an actual time series. In addition, as is discussed herein, each conditional feature can be considered to be an actual time series, decomposition module 118 can decompose each conditional feature time series into trend, seasonal and residual components, and generate modified conditional feature time series data.

In accordance with one or more embodiments, decomposition module 118 can use Fourier time series decomposition, or Fourier transformation, to determine the trend, seasonal and residual components of an actual time series. In accordance with disclosed embodiments, decomposition module 118 can pass the actual data values and the corresponding values of each conditional feature to the Fourier transformation to decompose each actual data value into its trend, seasonal and residual components.

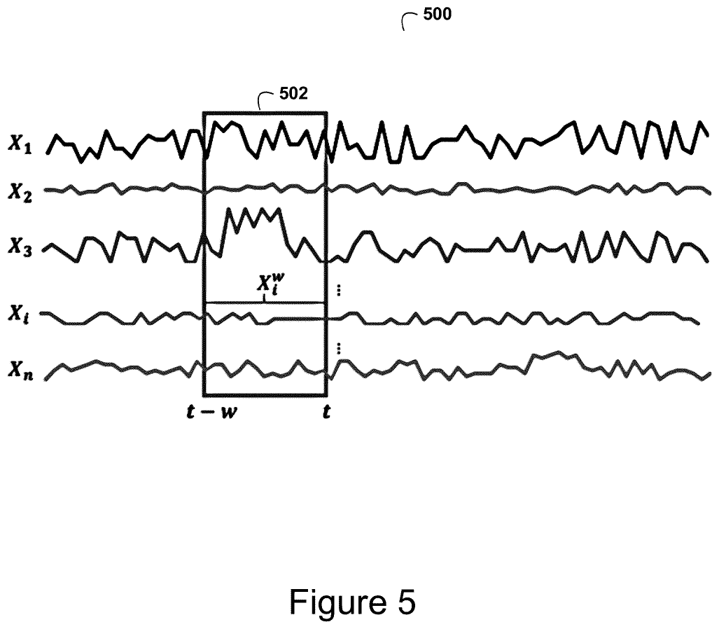

FIG. 5 provides an exemplary example illustrating time series data decomposition involving actual time series data values in accordance with one or more embodiments. In example 500, Xₜ can represent the actual data values in an actual time series. Continuing with the PRBU status example, X₁ can represent a time series of actual PRBU status data values. In addition, in example 500, X₂, X₃, Xᵢ and Xₙ can each represent a conditional feature. In example 500, window 502 corresponds to a number of time intervals, w, with the left-most time interval in window 502 being designated as t-w and the right-most time interval being designated as t. Each time interval in window 502 has a corresponding actual data value in X₁ and corresponding conditional feature values in X₂, X₃, Xᵢ and Xₙ.

In accordance with one or more embodiments of the present disclosure, decomposition module 118 can pass the actual data values of X₁ in window 502 along with the corresponding conditional feature values of X₂, X₃, Xᵢ and Xₙ in window 502 to a Fourier transformation module to determine the trend, seasonal and residual component values of each actual data value of X₁ in window 502. Window 502 can be moved left or right along the timeline to take into account another set of actual data values in X₁. The set of actual data values in X₁ in a given window 502 can overlap to some degree data values can be included in more than one instance of window 502.

By way of a further non-limiting example, decomposition module 118 can use a seasonality time series decomposition in addition to or in place of the Fourier transformation used in Fourier time series decomposition. Using the additive approach discussed in connection with Expr. (1), decomposition module 118 can determine the trend component of a time series using moving average method to identify one or more underlying patterns, subtract the trend component from the original series to obtain a remainder time series that has the seasonal and residual components of the time series, group the remainder time series by season (e.g., group data values by day per month in the case of daily actual data values) to identify the seasonal component of the original time series, and determine the residual component for the original time series by subtracting the trend and seasonality components from the original time series.

Using the multiplicative approach discussed in connection with Expr (2), the original time series can be divided by the identified trend component to determine the remainder time series and the residual component of the original times series can be determined by dividing the original time series by the product of the trend and seasonal components of the original time series.

In accordance with one or more embodiments, decomposition module 118 can decompose data values in a conditional feature time series into trend, seasonal and residual components and generate modified conventional feature time series data by removing the residual component. In accordance with one or more embodiments, trend and seasonal components from the actual time series data values can be retained in the modified time series data values. Decomposition module 118 can provide the modified conventional feature time series data as part of training data 120 used to train generator 106. In accordance with one or more embodiments, training data 120 can include unmodified conditional feature data

Referring again to FIG. 1, regularization module 122 can generate weights 124 using weighting parameter data 112. In accordance with one or more embodiments, weights 124 can be used to account for the impact of holidays or special events, which can introduce unusual patterns in the data that regular seasonality and trend components may not capture.

In accordance one or more embodiments, weights 124 can be used as a regularization for generator 106 to improve its ability to generalize on unseen data and prevent generator 106 from overfitting training data 120. By way of some non-limiting examples, weights 124 can be used to regulate the effects of holidays. By way of some non-limiting examples, smaller weight values can be used to limit holiday effects unless supported by data. In other words, smaller values (e.g., 0 to 1) can be used to regularize the holiday effect and reduce overfitting, while larger values (e.g., 10) can be used to allow more pronounced holiday effect. In accordance with one or more embodiments, cross validation can be used to optimize the prior scale parameter.

In accordance with one or more embodiments, weighting parameter data 112 can include a prior scale, e.g., a holiday scale, a set of holidays, a model parameter for each holiday of the set representing the effect of the holiday. Regularization modules 122 can determine a regularization term using the weighting parameter data 112 using the following expression:

$$L = \frac{λ}{2} \sum β {h}^{2} , \qquad Expr . ( 3 )$$

where L represents the regularization term, or weight, for holidays used by generator 106, λ presents the holiday prior scale (e.g., a zero Laplace Scale, or ZLPS), h represents a given holiday in a set of holidays and βh can be a model parameter representing the effect of a given holiday in the set of holidays.

In accordance with one or more embodiments, weighting parameter data 112 can include a zero Laplace prior scale, ZLPS, which can be used to control the degree of regularization applied to trend and seasonal components and other data, such as holiday, event, etc. data. The ZLPS scale parameter can determine how much a prior belief (e.g., that trends or seasonal changes are smooth) influences the generator's 106 fit. Zero Laplace refers to a prior assumption that certain data, such as trend and seasonal data component, holiday data, event data, etc., do not vary too abruptly unless there is strong evidence in the data. A prior scale can be used to control how strongly the prior assumption is enforced. A smaller prior scale results in stronger regularization, smoothing the model and avoiding overfitting. A larger prior scale allows the model to react more flexibly to the data.

A trend prior scale can be used to control how quickly the trend component of a time series can change over time. Smaller values can be used to smooth the trend, larger values can be used to allow for more abrupt changes. A seasonal prior scale can be used to regularize seasonal patterns to prevent overfitting to small fluctuations. A holiday prior scale can be used to regularize effects of holidays. As discussed above, smaller values can be used to limit holiday effects unless supported by data, while a larger value can allow for more pronounced holiday effect.

In example 100, generator 106 can use noise 110 to generate time series input 126. In accordance with one or more embodiments, noise 110 can be an initial seed comprising a vector of random values sampled from a distribution, e.g., a normal or uniform distribution. Noise 110 can be used to provide generator 106 with an initial randomness that generator 106 can use to create diverse synthetic time output. Noise 110 can be represented using the following expression:

$$Zi ϵ {R}^{n} , \qquad Expr . ( 4 )$$

where Z can be used as noise 110 and represents a vector of random values, R can represent the set of real numbers and n can represent the dimensionality of latent space. By way of a non-limiting example, the length of the seed vector, Z, can define the dimensionality of the latent space of GAN 104. By way of a further non-limiting example, where n is equal to 5, Z=[0.3,−2.05,1.4,−0.76,0.12], where the values are sampled from a normal distribution.

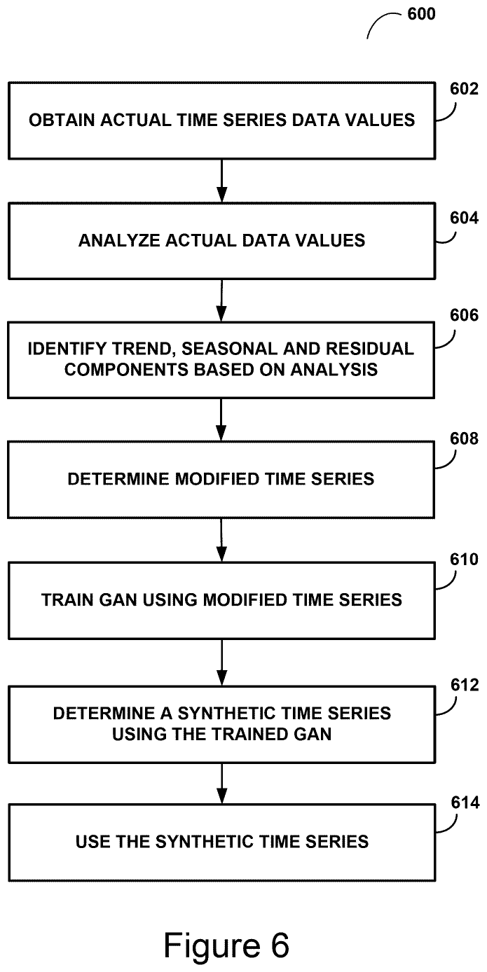

FIG. 6 provides a synthetic time series generation process flow in accordance with one or more embodiments of the present disclosure. Process flow 600 can be performed by synthetic time series engine. In accordance with one or more embodiments, process flow 600 can be used to train GAN 104 to generate synthetic time series data 136, which can then be used to perform time series analysis.

At step 602, time series data values can be obtained. By way of a non-limiting example, time series data values can be obtained by decomposition module 118 from real data 116.

At step 604, the actual data values can be analyzed. By way of a non-limiting example, step 604 can be performed by decomposition module 118. At step 606, trend, seasonal and residual components of the actual time series data values can be identified based on the analysis. By way of a non-limiting example, as discussed herein, decomposition module 118 can analyze an actual time series comprising actual data values obtained from real data 116, and identify the trend, seasonal and residual components of the actual data values. As discussed herein, in accordance with one or more disclosed embodiments, decomposition module 118 can analyze the actual data values and identify the trend, seasonal and residual components of each actual data value using conditional transfer feature data 114 corresponding to one or more conditional transfer features.

At step 608, a modified time series can be determined. By way of a non-limiting example, decomposition module 118 can determine the modified time series using the actual time series obtained at step 602 and the trend, seasonal and residual components of the actual data values identified at step 606. In accordance with one or more embodiments, decomposition module 118 can determine the modified time series by removing the residual component from each actual data value of the actual time series. In accordance with one or more embodiments, trend and seasonal components from the actual time series data values can be retained in the modified time series data values.

At step 610, a GAN can be trained using the modified time series. By way of a non-limiting example, step 610 can be performed by GAN 104. By way of a further non-limiting example, generator 106 can use training data including modified time series data to learn to generate synthetic time series data. In accordance with one or more embodiments, the generator 106 can be trained using weights 124. In accordance with one or more embodiments, training data can include conditional transfer feature data 114, which can be modified to remove the residual component.

At step 612, a synthetic time series can be determined using the trained GAN. By way of a non-limiting example, step 612 can be performed by generator 106 of GAN 104.

At step 614, the synthetic time series is used. Continuing with the PRBU status example, the trained GAN 104 can be used to generate synthetic buffer status time series data for a PRBU. The synthetic PRBU buffer status time series data can be used in place of, or in addition to actual PRBU buffer status information to manage data packets reception fluctuations, etc.

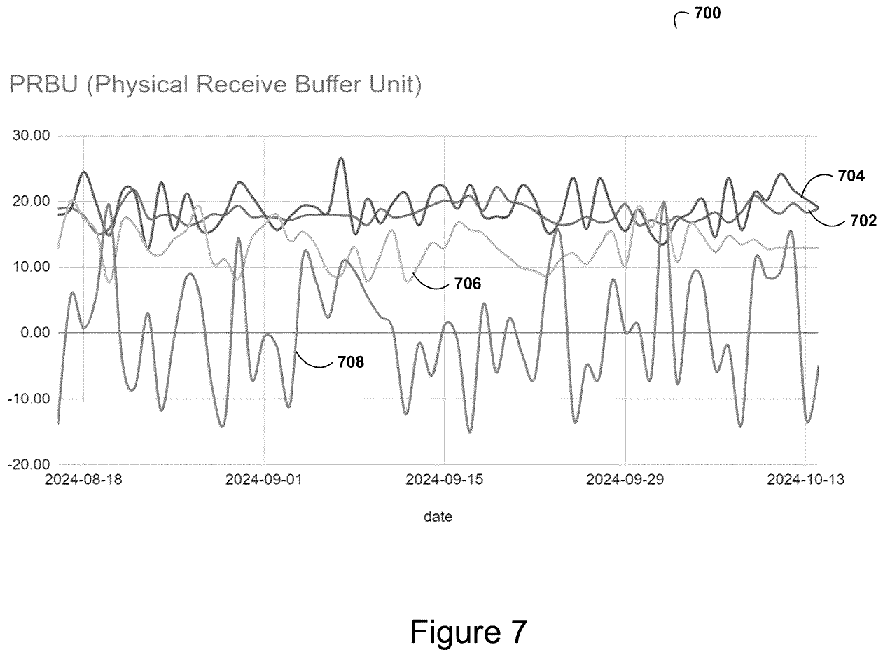

FIG. 7 provides an exemplary example graphically illustrating actual PRBU time series data and synthetic PRBU synthetic time series data generated in accordance with one or more embodiments of the present disclosure. The graph shown in example 700 charts actual PRBU time series data 702 and synthetic PRBU time series data 704 generated using disclosed embodiments. The graph in example 700 also includes a charting of synthetic PRBU time series data 706 and 708 generated by, respectively, a conventional GAN and a conventional cGAN adapted to generate time series data. As is demonstrated in example 700, synthetic PRBU time series data 704 generated using disclosed embodiments more accurately reflects the actual PRBU time series data 702 than the synthetic PRBU time series data 706 and 708 generated by the conventional GANs.

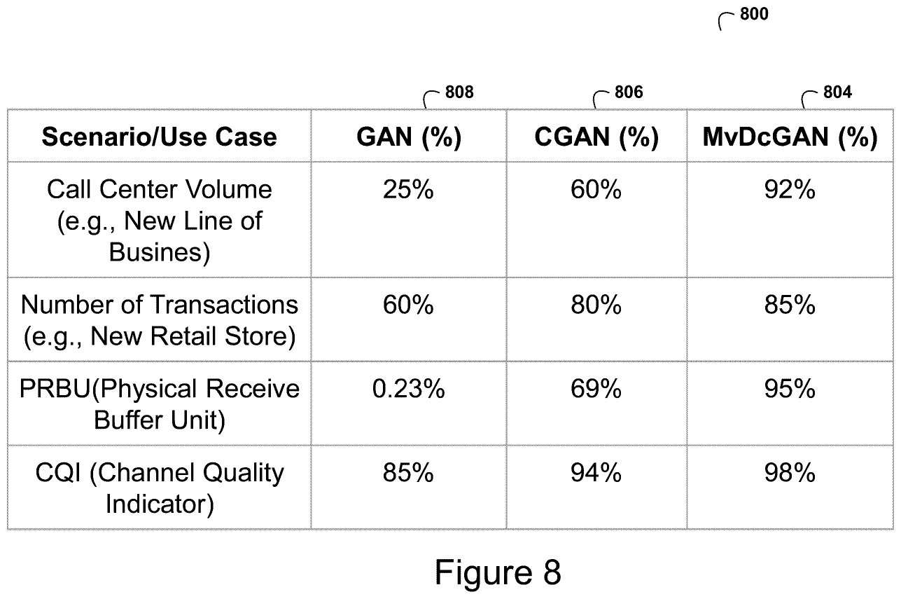

FIG. 8 provides an example illustrating the accuracy of synthetic time series data generated in connection with a number of use cases in accordance with one or more embodiments of the present disclosure. In example 800, column 804 indicates the accuracy of synthetic time series data generated using disclosed embodiments. Columns 806 and 808 indicate the accuracy of synthetic time series data generated using, respectively, a conventional cGAN and a convention GAN adapted to generate time series data. As shown in example 800, in each one of the use cases, the synthetic time series data generated using disclosed embodiments is the most accurate than synthetic time series data generated using conventional GANs adapted to generate time series data. In the PRBU use case, the synthetic PRBU time series data was found to be 95% accurate, while the other two approaches were much less accurate.

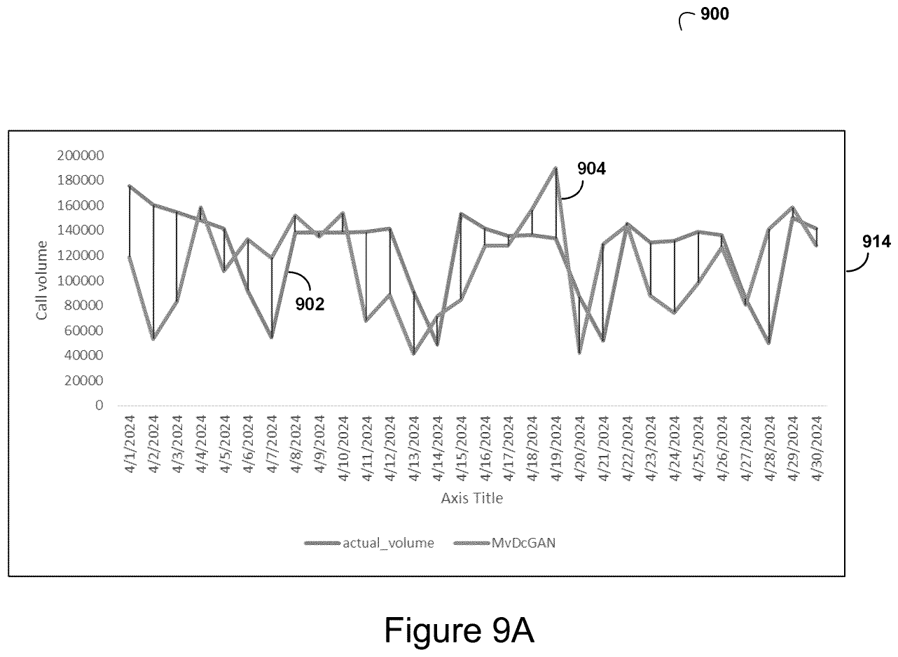

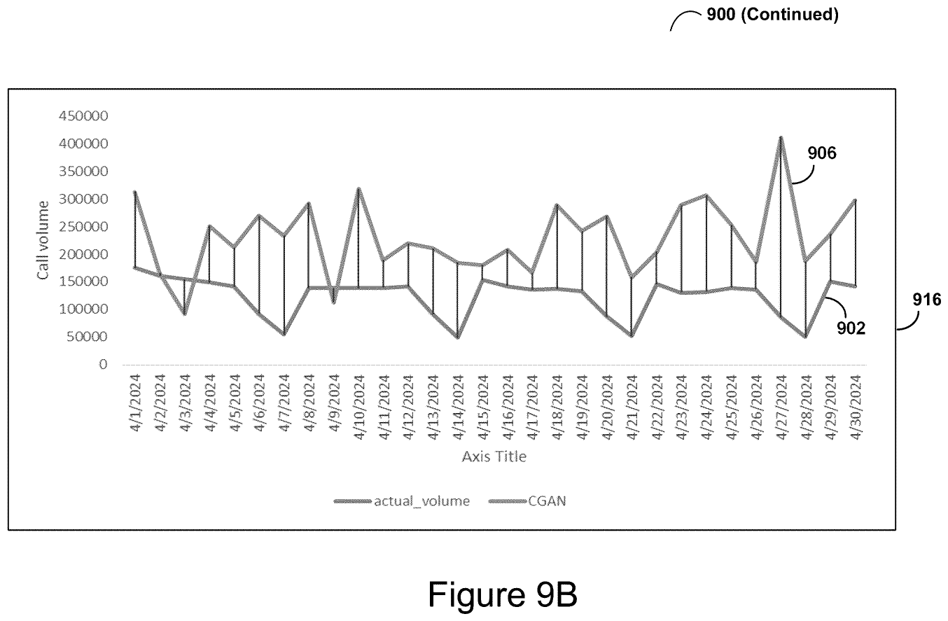

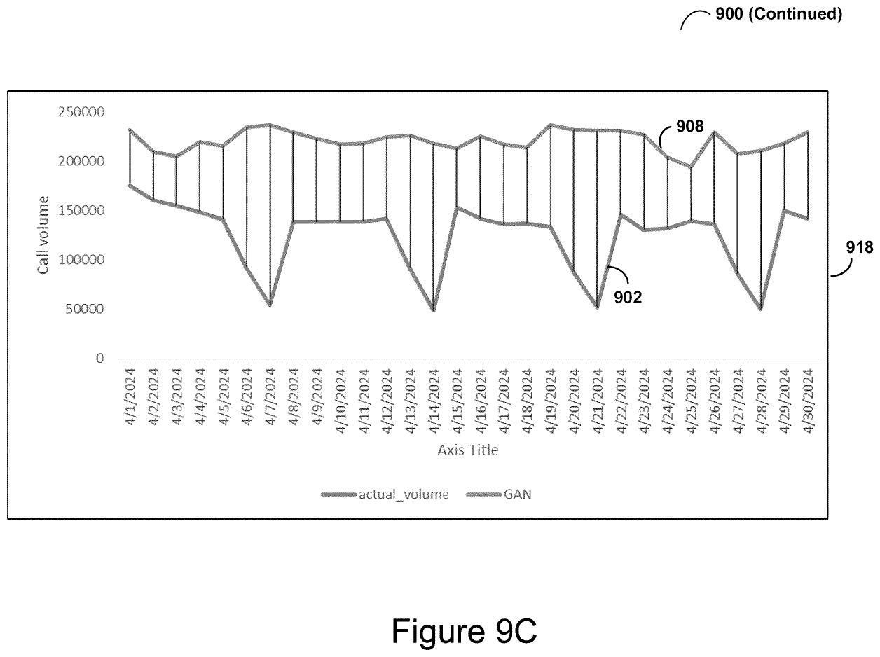

Another use case shown in example 800 involves a call center and an associated volume of calls. FIG. 9, which includes FIGS. 9A, 9B and 9C, provides an exemplary example graphically illustrating actual call center volume time series data and synthetic call center volume time series data generated in accordance with one or more embodiments of the present disclosure.

With reference to FIG. 9A, in example 900, graph 914 charts synthetic call center volume time series data 904 generated in accordance with disclosed embodiments relative to actual call center volume time series data 902. Graph 916, in FIG. 9B, charts synthetic call center volume time series data 906 generated using a cGAN relative to actual call center volume time series data 902. Graph 918, in FIG. 9C, charts synthetic call center volume time series data 908 generated using a GAN relative to actual call center volume time series data 902. As can be seen in example 900 shown in FIGS. 9A, 9B and 9C, synthetic call center volume time series data 904 generated in accordance disclosed embodiments more accurately reflects the actual call center volume time series data. Reference is made to FIG. 8, which further demonstrates that the synthetic call center volume time series data generated in accordance with embodiments of the present disclosure has a 92% accuracy score (shown in column 804) as compared with the 25% accuracy score (shown in column 808) of synthetic call center volume time series data generated using a conventional cGAN and the 60% accuracy score (shown in column 806) of synthetic call center volume time series data generated using a conventional GAN, assisting in a more effective allocation of resources.

Another use case illustrated in example 800 is channel quality indicator, CQI, which can be used an indicator of the quality of a communications channel. By way of a non-limiting example, CQI can be used indicate the quality of the communications transmitted to and from UEs in a telecommunications network. As shown in example 800, the synthetic CQI time series data generated in accordance with disclosed embodiments is more accurate than the synthetic CQI time series data generated using the conventional GANs.

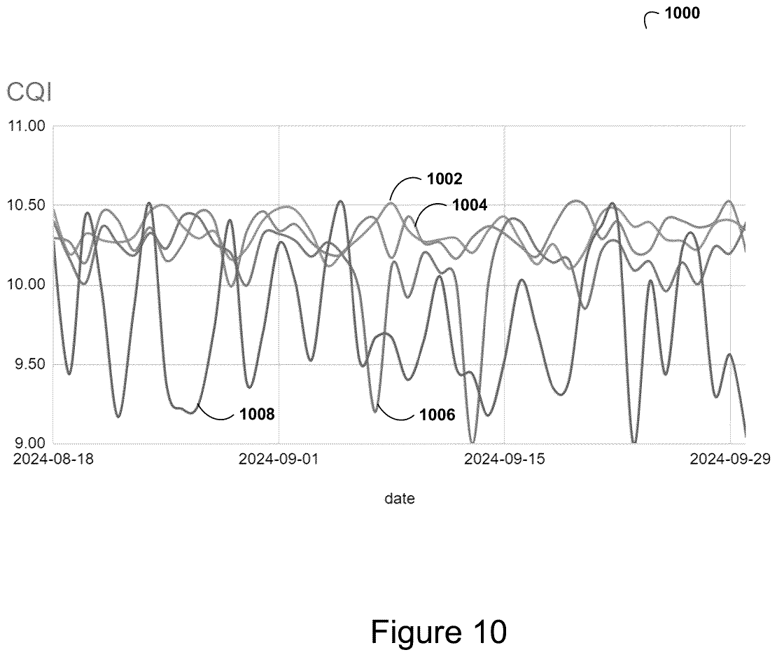

Reference is made to FIG. 10, which provides an exemplary example graphically illustrating actual CQI time series data and synthetic CQI synthetic time series data generated in accordance with one or more embodiments of the present disclosure. The graph shown in example 1000 charts actual CQI time series data 1002 and synthetic CQI time series data 1004 generated using disclosed embodiments. Example 1000 also includes a graph of synthetic CQI time series data 1006 generated by a conventional cGAN and a graph of synthetic CQI time series data 1008 generated by a conventional GAN. As is demonstrated in example 1000, synthetic CQI time series data 1004 generated using disclosed embodiments more accurately reflects actual CQI time series data 1002 than the synthetic CQI time series data 1006 and 1008 generated by the conventional GANs.

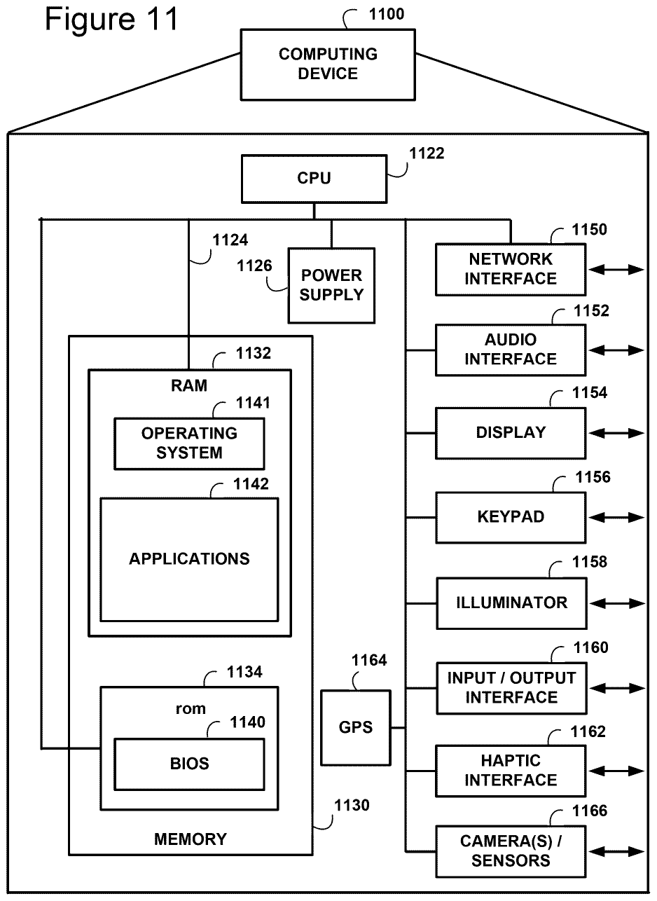

FIG. 11 is a block diagram illustrating a computing device showing an example of a client or server device that can be used to implement functionality described in connection with various embodiments of the disclosure.

The computing device 1100 may include more or fewer components than those shown in FIG. 11, depending on the deployment or usage of the device 1100. For example, a server computing device, such as a rack-mounted server, may not include audio interfaces 1152, displays 1154, keypads 1156, illuminators 1158, haptic interfaces 1162, GPS receivers 1164, or cameras/sensors 1166. Some devices may include additional components not shown, such as graphics processing unit (GPU) devices, cryptographic co-processors, artificial intelligence (AI) accelerators, or other peripheral devices.

As shown in FIG. 11, the device 1100 includes a central processing unit (CPU) 1122 in communication with a mass memory 1130 via bus 1124. The computing device 1100 also includes one or more network interfaces 1150, an audio interface 1152, a display 1154, a keypad 1156, an illuminator 1158, an input/output interface 1160, a haptic interface 1162, an optional global positioning systems (GPS) receiver 1164 and a camera(s) or other optical, thermal, or electromagnetic sensors 1166, and power supply 1126. Device 1100 can include one camera/sensor 1166 or a plurality of cameras/sensors 1166. The positioning of the camera(s)/sensor(s) 1166 on the device 1100 can change per device 1100 model, per device 1100 capabilities, and the like, or some combination thereof.

In some embodiments, the CPU 1122 may comprise a general-purpose CPU. The CPU 1122 may comprise a single-core or multiple-core CPU. The CPU 1122 may comprise a system-on-a-chip (SoC) or a similar embedded system. In some embodiments, a GPU may be used in place of, or in combination with, a CPU 1122. Mass memory 1130 may comprise a dynamic random-access memory (DRAM) device, a static random-access memory device (SRAM), or a Flash (e.g., NAND Flash) memory device. In some embodiments, mass memory 1130 may comprise a combination of such memory types. In one embodiment, the bus 1124 may comprise a Peripheral Component Interconnect Express (PCIe) bus. In some embodiments, the bus 1124 may comprise multiple busses instead of a single bus.

Mass memory 1130 illustrates another example of computer storage media for the storage of information such as computer-readable instructions, data structures, program modules, or other data. Mass memory 1130 stores a basic input/output system (“BIOS”) 1140 (e.g., as part of ROM 1134) for controlling the low-level operation of the computing device 1100. The mass memory also stores an operating system 1141 for controlling the operation of the computing device 1100.

Applications 1142 may include computer-executable instructions which, when executed by the computing device 1100, perform any of the methods (or portions of the methods) described previously in the description of the preceding Figures. In some embodiments, the software or programs implementing the method embodiments can be read from a hard disk drive (not illustrated) and temporarily stored in RAM 1132 by CPU 1122. CPU 1122 may then read the software or data from RAM 1132, process them, and store them to RAM 1132 again.

The computing device 1100 may optionally communicate with a base station (not shown) or directly with another computing device. Network interface 1150 is sometimes known as a transceiver, transceiving device, or network interface card (NIC).

The audio interface 1152 produces and receives audio signals such as the sound of a human voice. For example, the audio interface 1152 may be coupled to a speaker and microphone (not shown) to enable telecommunication with others or generate an audio acknowledgment for some action. Display 1154 may also include a touch-sensitive screen arranged to receive input from an object such as a stylus or a digit from a human hand.

Keypad 1156 may comprise any input device arranged to receive input from a user. Illuminator 1158 may provide a status indication or provide light.

The computing device 1100 also comprises an input/output interface 1160 for communicating with external devices, using communication technologies, such as USB, infrared, Bluetooth™, or the like. The haptic interface 1162 provides tactile feedback to a user of the client device.

The optional GPS transceiver 1164 can determine the physical coordinates of the computing device 1100 on the surface of the Earth, which typically outputs a location as latitude and longitude values. GPS transceiver 1164 can also employ other geo-positioning mechanisms, including, but not limited to, triangulation, assisted GPS (AGPS), E-OTD, CI, SAI, ETA, BSS, or the like, to further determine the physical location of the computing device 1100 on the surface of the Earth. In one embodiment, however, the computing device 1100 may communicate through other components, provide other information that may be employed to determine a physical location of the device, including, for example, a MAC address, IP address, or the like.

The present disclosure has been described with reference to the accompanying drawings, which form a part hereof, and which show, by way of a non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by computing device, an actual time series comprising actual data values;
analyzing, by the computing device, the actual data values and identifying, based on the analysis, at least a residual component corresponding to each data value of the actual time series;
determining, by the computing device, a modified time series using the actual time series, the determining comprising determining modified data values by removing the residual component from each actual data value of the actual time series;
training, by the computing device, a generative adversarial network (GAN) comprising a generator and a discriminator, the modified time series being used as training data for the generator;
determining, by the computing device, a synthetic time series comprising synthetic data values using the trained GAN; and
using, by the computing device, the synthetic time series in place of or in combination with actual time series data.

2. The method of claim 1, wherein determining a modified time series further comprises:
determining, by the computing device, the modified data values by retaining a trend component and a seasonal component of each actual data value of the actual time series.

3. The method of claim 1, further comprises:
generating, by the computing device, a set of weights associated with the actual time series, wherein the training the GAN further comprises training the generator using the modified time series and the set of weights as training data for the generator.

4. The method of claim 1, wherein the training the GAN further comprises:
training, by computing device, the GAN using the actual time series as training data for the discriminator.

5. The method of claim 1, wherein the analyzing the actual time series further comprising:
using, by the computing device, Fourier time series decomposition to identify a trend component, a seasonal component and the residual component of each data value of the actual time series.

6. The method of claim 1, wherein the analyzing the actual time series further comprising:
using, by the computing device, a moving average method to identify a trend component of each data value of the actual time series.

7. The method of claim 6, further comprising:
generating, by the computing device, a second modified time series using the actual time series, the generating comprising generating second modified data values by removing the trend component from each data value of the actual time series;
determining, by the computing device, a seasonal component for each second modified each data value by grouping the data values from the second modified time series into a number of seasonal groupings; and
determining, by the computing device, the residual component of each actual data value of the actual time series by removing the trend component and the seasonal component from each actual data value.

8. The method of claim 1, further comprising:
using, by the computing device, conditional feature time series data in determining the modified time series.

9. The method of claim 1, wherein the determining a synthetic time series further comprising:
generating, by the computing device, a random value as noise; and
providing, by the computing device, the random value to the trained GAN, the random value being used by the trained GAN to determine the synthetic time series.

10. The method of claim 1, further comprising:
analyzing, by the computing device, a conditional feature time series comprising actual conditional feature data values and identifying, based on the analysis, a trend component, seasonal component and residual component corresponding to each data value of the conditional feature time series;
determining, by the computing device, a modified conditional feature time series using the conditional feature time series, the determining comprising determining modified conditional feature data values by removing the residual component from each actual conditional feature data value of the conditional feature time series; and
training, by the computing device, the generator using the training data comprising the modified conditional feature time series.

11. The method of claim 1, wherein the using the synthetic time series further comprising:
using, by the computing device, the synthetic data values of synthetic time series as physical receive buffer unit (PRBU) status information to allocate resources of a telecommunications network.

12. The method of claim 1, wherein the using the synthetic time series further comprising:
using, by the computing device, the synthetic data values of synthetic time series as call center volume information to allocate call center resources.

13. A non-transitory computer-readable storage medium tangibly encoded with computer-executable instructions that when executed by a processor associated with a computing device perform a method comprising:
obtaining an actual time series comprising actual data values;
analyzing the actual data values and identifying, based on the analysis, at least a residual component corresponding to each data value of the actual time series;
determining a modified time series using the actual time series, the determining comprising determining modified data values by removing the residual component from each actual data value of the actual time series;
training a generative adversarial network (GAN) comprising a generator and a discriminator, the modified time series being used as training data for the generator;
determining a synthetic time series comprising synthetic data values using the trained GAN; and
using the synthetic time series in place of or in combination with actual time series data.

14. The non-transitory computer-readable storage medium of claim 13, the method further comprises:
generating a set of weights associated with the actual time series, wherein the training the GAN further comprises training the generator using the modified time series and the set of weights as training data for the generator.

15. The non-transitory computer-readable storage medium of claim 13, wherein the training the GAN further comprises:
training the GAN using the actual time series as training data for the discriminator.

16. The non-transitory computer-readable storage medium of claim 13, wherein the analyzing the actual time series further comprising:
using Fourier time series decomposition to identify a trend component, a seasonal component and the residual component of each data value of the actual time series.

17. The non-transitory computer-readable storage medium of claim 13, wherein the analyzing the actual time series further comprising:
using a moving average method to identify a trend component of each data value of the actual time series;
generating a second modified time series using the actual time series, the generating comprising generating second modified data values by removing the trend component from each data value of the actual time series;
determining a seasonal component for each second modified each data value by grouping the data values from the second modified time series into a number of seasonal groupings; and
determining the residual component of each actual data value of the actual time series by removing the trend component and the seasonal component from each actual data value.

18. The non-transitory computer-readable storage medium of claim 13, the method further comprising:
using conditional feature time series data in determining the modified time series.

19. The non-transitory computer-readable storage medium of claim 13, wherein the determining a synthetic time series further comprising:
generating a random value as noise; and
providing the random value to the trained GAN, the random value being used by the trained GAN to determine the synthetic time series.

20. A device comprising:
a processor, configured to:
obtain an actual time series comprising actual data values;
analyze the actual data values and identifying, based on the analysis, at least a residual component corresponding to each data value of the actual time series;
determine a modified time series using the actual time series, the determining comprising determining modified data values by removing the residual component from each actual data value of the actual time series;
train a generative adversarial network (GAN) comprising a generator and a discriminator, the modified time series being used as training data for the generator;
determine a synthetic time series comprising synthetic data values using the trained GAN; and
use the synthetic time series in place of or in combination with actual time series data.
